(19) United States
(12) Patent Application Publication
(10) Pub. No.: US 2011/0169918 A1
(43) Pub. Date: Jul. 14, 2011

(54) 3D IMAGE SENSOR AND STEREOSCOPIC CAMERA HAVING THE SAME

(75) Inventor: Sang-Keun Yoo, Daejeon-si (KR)

(73) Assignee: HANVISION CO., LTD., Daejeon-si (KR)

(21) Appl. No.: 12/976,161

(22) Filed: Dec. 22, 2010

(30) Foreign Application Priority Data
Jan. 8, 2010 (KR) 10-2010-0002010

(51) Int. Cl. H04N 13/02

(52) U.S. Cl. 348/46; 348/E13.074

(57) ABSTRACT

A three-dimensional (3D) image sensor and a stereoscopic camera having the same are provided. The 3D image sensor includes one or more image acquisition regions, each image acquisition region having a plurality of pixels; and an output signal generation controller configured to extract pixel signals from two regions of interest (ROIs) set within the image acquisition regions and output image signals based on the pixel signals, the ROIs being apart from each other. The output signal generation controller may minutely adjust the position of at least one of the ROIs in accordance with a convergence adjustment signal. The output signal generation controller may vertically or horizontally move each of the ROIs in accordance with a camera shake signal and may thus correct camera shake. The output signal generation controller may align the ROIs with left and right lenses in an optical system. The output signal generation controller may vertically or horizontally move each of the ROIs in accordance with an optical axis correction signal and may thus correct an optical axis error resulting from an optical is axis misalignment.

### CROSS-REFERENCE TO RELATED APPLICATION(S)

This application claims the benefit under 35 U.S.C. §119(a) of Korean Patent Application No. 10-2010-0002010, filed on Jan. 8, 2010, in the Korean Intellectual Property Office, the entire disclosure of which is incorporated herein by reference for all purposes.

### BACKGROUND

1. Field

The following description relates to a three-dimensional (3D) imaging technique, and more particularly, to a 3D image sensor and a stereoscopic camera having the same.

2. Description of the Related Art

Stereoscopic cameras are largely classified into binocular and monocular stereoscopic cameras. Binocular stereoscopic cameras are classified into a side-by-side type, a convergence type, and a horizontal axis movement type. The side-by-side-type stereoscopic camera is characterized by two cameras fitted to a rig in parallel, such that the distance between the two cameras can be varied to adjust the degree of convergence. The side-by-side-type of stereoscopic camera cannot have the distance between the cameras reduced to a distance smaller than the size of the two cameras. This inability to reduce the distance will produce excessive binocular disparity in a close-up photography and may thus cause too much eye fatigue or visual effects in the people viewing the scene. In addition, the side-by-side-type stereoscopic camera may not be able to vary its shooting range in accordance with convergence. The convergence-type stereoscopic camera adjusts convergence by selectively rotating a plurality of cameras employed therein while maintaining the distance between the cameras. The convergence-type stereoscopic camera can adjust its shooting range in accordance with a convergence distance. However, the convergence-type stereoscopic camera may result in image distortions especially when subjects are close with large convergence angle. The horizontal axial movement-type stereoscopic camera adjusts convergence by adjusting a relative position of an imaging device to a lens system. The horizontal axial movement-type stereoscopic camera can easily adjust convergence, but has a complicated structure and is thus relatively difficult to manufacture and operate.

Monocular stereoscopic cameras have a simple optical system structure which includes a lens, a zoom lens and a beam splitter. However, the use of beam splitters may cause various problems such as picture quality degradation or image deterioration resulting from chromatic aberration. In addition, since there is a fixed, standard configuration for beam splitters, the adjustment of convergence by monocular stereoscopic cameras can be limited by the zooming and focusing of their zoom lenses.

### SUMMARY

The following description relates to a three-dimensional (3D) image sensor which can simplify the structure of an optical system and provide excellent-quality 3D images.

The following description also relates to a stereoscopic camera, which has a simple structure and can easily adjust convergence, and a 3D image sensor for use in the stereoscopic camera.

The following description also relates to facilitating the setting of regions of interest (ROIs) and the correction of camera shake or error resulting from an optical axis misalignment.

In one general aspect, there is provided a 3D image sensor including one or more image acquisition regions, each image acquisition region having a plurality of pixels; and an output signal generation controller configured to extract pixel signals from two regions of interest (ROIs) set within the image acquisition regions and output image signals based on the pixel signals, the ROIs being apart from each other.

The ROIs may be symmetrical with respect to a line drawn between the image acquisition regions.

The 3D image sensor may also include a separation region configured to be provided between the ROIs and to have no pixels therein.

The 3D image sensor may be implemented on a single substrate obtained from a single wafer.

The 3D image sensor may minutely adjust the position of at least one of the ROIs in accordance with a convergence signal, thereby facilitating the adjustment of convergence.

The 3D image sensor may vary the distance between the ROIs in accordance with the distance between left and right lenses in an optical system.

The 3D image sensor may correct camera shake by vertically or horizontally moving each of the ROIs.

The 3D image sensor may correct an error resulting from an optical lens misalignment in the optical system by vertically or horizontally moving each of the ROIs.

Other features and aspects may be apparent from the following detailed description, the drawings, and the claims.

### BRIEF DESCRIPTION OF THE DRAWINGS

FIG. 1 is a diagram illustrating an example of a three-dimensional (3D) image sensor;

FIG. 2 is a diagram illustrating various optical modules having different distances between lenses;

FIGS. 3 and 4 are diagrams illustrating examples of how to set regions of interest (ROIs) for a given convergence distance;

FIG. 5 is a diagram illustrating an example of a stereoscopic camera; and

FIGS. 6 and 7 are diagrams illustrating another example of the stereoscopic camera.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

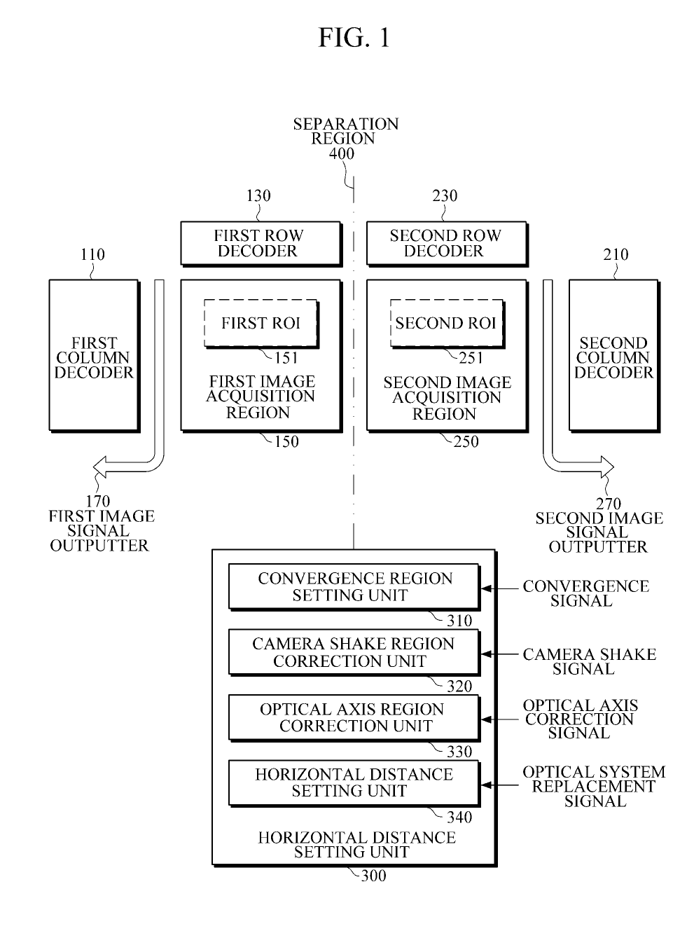

FIG. 1 is a diagram illustrating an example of a three-dimensional (3D) image sensor, and particularly, an example of a 3D complementary metal-oxide-semiconductor (CMOS) image sensor. Referring to FIG. 1, the 3D image sensor includes first and second image acquisition regions 150 and 250 and an output signal generation controller 300. Each of the first and second image acquisition regions 150 and 250 includes a plurality of pixels. The first and second image acquisition regions 150 and 250 includes first and second regions of interest (ROIs) 151 and 251, respectively, which are separate from each other. The output signal generation controller 300 extracts pixel signals from the first and second ROIs 151 and 251 and then outputs the extracted pixel signals as image signals for each eye.

An ROI may be set symmetrically on both sides of a center line drawn between the first and second image acquisition regions 150 and 250 for an efficient use of an effective pixel region of each of the first and second image acquisition regions 150 and 250, but the present invention is not restricted to this. A separation region 400 where there are no pixels is provided along the center line between the first and second image acquisition regions 150 and 250. More specifically, a region where no effective pixels are necessary may be set as the separation region 400.

The 3D image sensor may be fabricated by using a single substrate obtained from a single wafer. The first image acquisition region 150 may include an effective pixel region in which a plurality of CMOS pixel circuits are arranged in the form of a matrix. When the size of the effective pixel region is smaller than or the same as the size of a typical chip, the first image acquisition region 150 may be implemented as a single chip. On the other hand, if the size of the effective pixel region is larger than the size of a typical chip, the first image acquisition region 150 may be fabricated by integrating a plurality of chips formed using a single wafer into a single package.

The output signal generation controller 300 controls a first row decoder 130 and a first column decoder 110 and thus sets an ROI, i.e., the first ROI 151, within the first image acquisition region 150. Photons detected from the pixels within the first ROI 151 may be output to a first image signal output 170.

The second image acquisition region 250, like the first image acquisition region 150, may include a plurality of CMOS pixel circuits which are arranged in the form of a matrix. The output signal generation controller 300 controls a second row decoder 230 and a second column decoder 210 and thus sets an ROI, i.e., the second ROI 251, within the second image acquisition region 250. Photons detected from the pixels within the second ROI 251 may be output to a second image signal output 270.

A column decoder and a row decoder in a CMOS image sensor can read image signals from pixels within an effective pixel region as if reading data from a memory. The read image signals may be output in series via an image signal output in the CMOS image sensor.

The output signal generation controller 300 may include a convergence region setting unit 310, which adjust the position of at least one of the first and second ROIs 151 and 251 minutely in accordance with a convergence adjustment signal. The convergence adjustment signal may be provided by an external controller (not shown). When an optical system is designed to have a relatively wide focal range, it is possible to offer the benefits of changing the horizontal distance between the 3D image sensor and the optical system simply by varying the positions of the first and second ROIs 151 and 251 without a requirement of the mechanical movement of the optical system. Therefore, it is possible to facilitate the setting of convergence.

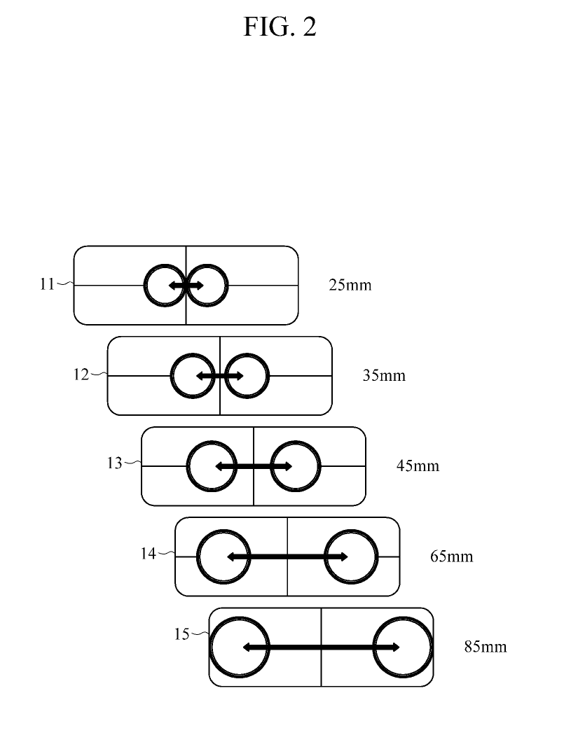

The output signal generation controller 300 may also include a horizontal distance setting unit 340, which appropriately adjusts the positions of the first and second ROIs 151 and 251 according to the distance between left and right lenses in the optical system and can thus align the first and second ROIs 151 and 251 with the left and right lenses in the optical system. The distance between lenses may be varied according to the distance from a subject or the purpose of a whole image acquisition process. In order to provide various distances between lenses, a predefined mechanical mechanism may be employed in the 3D image sensor, or a plurality of optical systems may be selectively used. FIG. 2 is a diagram of various optical modules having different distances between lenses. Referring to FIG. 2, the distance between lenses may correspond to the distance between the eyes. In the case of typical optical modules, the distance between sensor units cannot be dynamically changed, but is fixed to one of the following standard values: 25 mm, 35 mm, 45 mm, 65 mm, and 85 mm. The larger the distance between lenses, the larger the area of a sensing region.

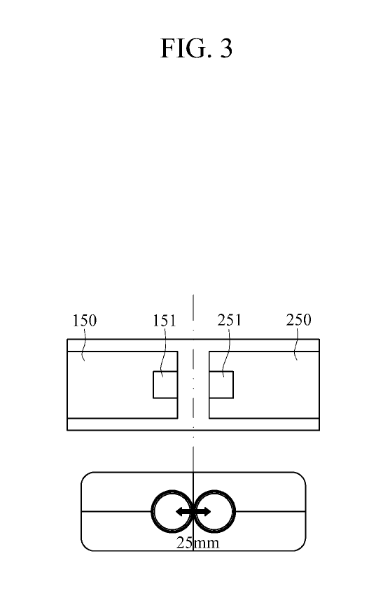

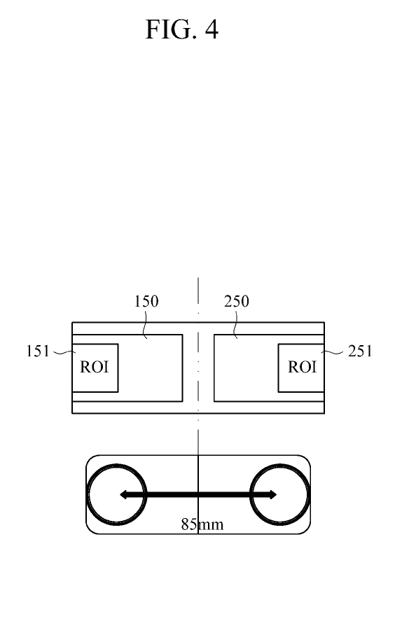

FIGS. 3 and 4 are diagrams illustrating examples of how to set ROIs for a given distance between lenses. Referring to FIG. 3, when the distance between lenses is 25 mm, the first ROI 151 may be set on the far right side of the first image acquisition region 150, and the second ROI 251 may be set on the far left side of the second image acquisition region 250. As a result, the distance between the first and second ROIs 151 and 251 and the area of the first and second ROIs 151 and 251 can both be minimized.

On the other hand, referring to FIG. 4, when the distance between lenses or convergence distance is 85 mm, the first ROI 151 may be set on the far left side of the first image acquisition region 150, and the second ROI 251 may be set on the far right side of the second image acquisition region 250. As a result, the distance between the first and second ROIs 151 and 251 and the area of the first and second ROIs 151 and 251 can both be maximized.

The distance between lenses is normally set to be equal to an interocular distance of about 65 mm, and can be varied within the range of 25 mm to 65 mm during an image acquisition process. The area of the first and second image acquisition regions 150 and 250 combined may be set on the basis of a convergence distance of 65 mm. In order to support the convergence distance of 65 mm, a resolution of 4520×2764 is required. When the size of pixels is 2.8 μm, the size of a chip including both the first and second image acquisition regions 150 and 250 may be 12.66×7.74 mm². Due to the limitation of the size of chips that can be fabricated through a single process, the 3D image sensor may need to be fabricated by setting two chip areas on a wafer. The term ‘image acquisition region,’ as used herein, may indicate, but is not limited to, a single package device in which a plurality of chips are arranged. Since the 3D image sensor 100 is formed by using a single substrate obtained from a single wafer, the sensitivity of pixels can be uniformly maintained throughout the whole 3D image sensor.

The output signal generation controller 300 may also include a camera shake region correction unit 320, which corrects camera shake by vertically or horizontally moving the first or second ROI 151 or 251 in accordance with a camera shake signal. The camera shake signal may be provided by the external controller. Thus, camera shake can be corrected software-wise by moving the first or second ROI 151 or 251 in the opposite direction to the direction of the camera shake.

The output signal generation controller 300 may also include an optical axis region correction unit 330, which corrects an error resulting from an optical axis misalignment, i.e., an optical axis error, by vertically or horizontally moving each of the first and second ROIs 151 or 251 in accordance with an optical axis correction signal. The optical axis correction signal may vary according to the distance between the left and right lenses in the optical system because the degree of the optical axis error varies according to the distance between the left and right lenses in the optical system. When a stereoscopic camera is initially set up, one or more ROIs may be set such that the optical axis error can be automatically corrected. In this manner, it is possible to acquire an image with any optical defects corrected. The optical axis correction signal may also vary according to a zoom value of the optical system because an optical axis misalignment may occur according to optical depth.

This exemplary embodiment has been described taking a CMOS image sensor as an example, but the present invention is not restricted to a CMOS image sensor. For example, the 3D image sensor may be implemented as a charge-coupled device (CCD) image sensor, which is configured to sequentially output charges accumulated in an image acquisition region using a plurality of shift registers, convert the output charges into digital data, and extract some portions of the digital data and output the extracted digital data portions as image data using an output signal generation controller. In this case, an internal synchronization clock inside the CCD image sensor may not coincide with an external synchronization clock of the image data. More specifically, the internal synchronization clock may be much faster than the external synchronization clock, and a frame buffer corresponding to the size of an ROI set within the image acquisition region in the CCD image sensor may be needed in order to make the internal and external synchronization clocks coincide with each other. Alternatively, only a number of shift-registers in the CCD image sensor corresponding to an ROI may be activated. More specifically, only a number of row shift registers corresponding to the ROI may be activated, and only a number of column shift registers corresponding to a portion of the image acquisition region below the ROI may be activated, thereby lowering clock speed.

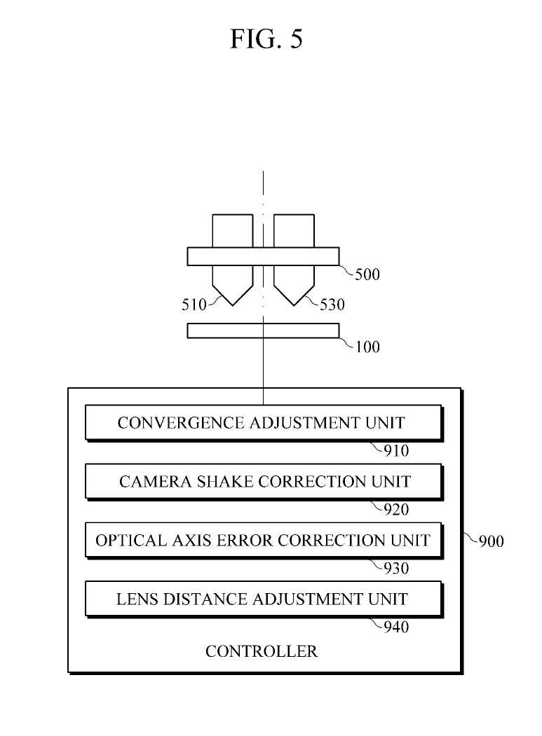

FIG. 5 is a diagram illustrating an example of a stereoscopic camera. Referring to FIG. 5, the stereoscopic camera includes a 3D image sensor 100 and an optical system 500 having a first lens group 510 and a second lens group 530, and a controller 900. The 3D image sensor 100 may have the same structure as the CMOS image sensor shown in FIG. 1. More specifically, the 3D image sensor 100 includes first and second image acquisition regions, which each include a plurality of pixels, a first ROI, which is set within the first image acquisition region 150 and acquires an image from the first lens group 510, a second ROI, which is set within the second image acquisition region and acquires an image from the second lens group 530, and an output signal generation controller, which generates two image signals respectively corresponding to the left and right eyes based on pixel signals extracted from the first and second ROIs and outputs the generated image signals to the outside of the 3D image sensor 100.

Each of the first and second lens groups 510 and 530 may be an ultra small camera lens module combining a plurality of lenses to control focusing. A mechanism for controlling a focal point by controlling the distance between lenses may be employed in each of the first and second lens groups 510 and 530. The first ROI, which is on the left side of the 3D image sensor 100, receives light collected from the first lens group 510, and the second ROI, which is on the left side of the 3D image sensor 100, receives light collected from the second lens group 530.

The controller 900 includes a convergence adjustment unit 910, which outputs a convergence adjustment signal in response to a user manipulation of the stereoscopic camera, and particularly, a knob or a sliding switch of the stereoscopic camera. The output signal generation controller of the 3D image sensor 100 includes, as a counterpart of the convergence adjustment unit 910, a convergence region setting unit, which adjusts the position of at least one of the first and second ROIs minutely in accordance with the convergence adjustment signal output by the convergence adjustment unit 910. Therefore, it is possible to easily adjust convergence without a mechanical movement of the optical system 500.

A plurality of optical systems having different distances between left and right lenses may be provided. Then, each of the plurality of optical systems may be selectively used as the optical system 500. The controller 900 also includes a lens distance adjustment unit 940, which has a lens distance detection circuit electrically determining which of the plurality of optical systems is being used as the optical system 500. For example, the lens distance adjustment unit 940 may determine which of the plurality of optical systems is being used as the optical system 500 based on a resistance measurement obtained from the optical system 500 by the controller 900. The output signal generation controller of the 3D image sensor 100 includes, as a counterpart of the lens distance adjustment unit 940, a horizontal distance setting unit, which aligns the first and second ROIs with left and right lenses in the optical system 500 based on the distance between the left and right lenses in the optical system 500.

The controller 900 also includes a camera shake correction unit 920, which detects a camera shake and outputs a camera shake signal for correcting the camera shake. The structure and operation of the camera shake correction unit 920 are well known to one of ordinary skill in the art to which the present invention pertains. The output signal generation controller of the 3D image sensor 100 includes, as a counterpart of the camera shake correction unit 920, a camera shake region correction unit, which vertically or horizontally moves at least one of the first and second ROIs in accordance with the camera shake signal output by the camera shake correction unit 920.

The controller 900 also includes an optical axis error correction unit 930, which detects an optical axis error, if any, in the first and second lens groups 510 and 530 and outputs an optical axis correction signal for correcting the optical axis error. For this, a lookup table may be created in advance based on measurements obtained, at the time of the assembly of the stereoscopic camera, from various ROIs while varying the distance between lenses according to convergence. Then, the optical axis error correction unit 930 can help the 3D image sensor 100 set optimum ROIs for any given convergence distance by referencing the lookup table while taking into consideration the optical properties of each of the first and second lens groups 510 and 530. The output signal generation controller of the 3D image sensor 100 includes, as a counterpart of the optical axis error correction unit 930, an optical axis region correction unit, which corrects an optical axis error by vertically or horizontally moving the first and second ROIs in accordance with the optical axis correction signal.

The optical axis correction signal may vary according to the distance between the left and right lenses in the optical system 500. The optical axis correction signal may also vary according to a zoom value of the optical system 500.

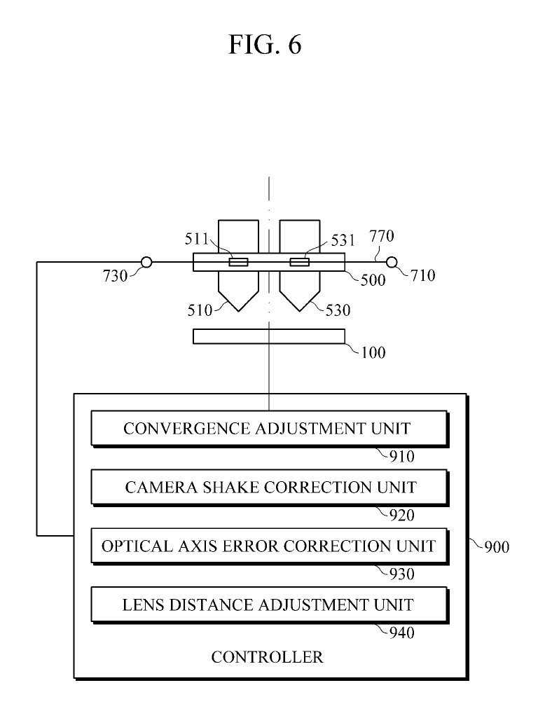

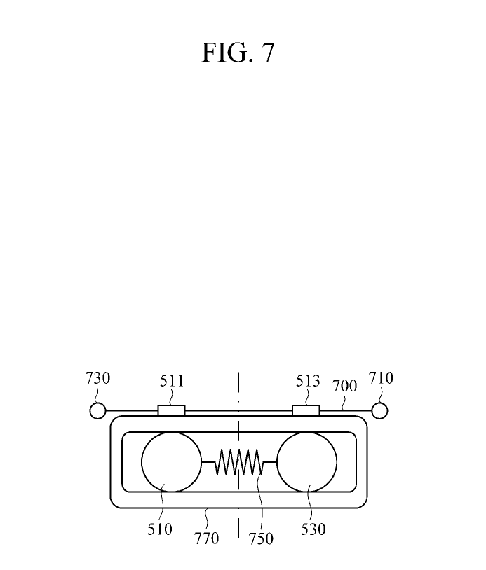

FIGS. 6 and 7 are diagrams illustrating another example of the stereoscopic camera. Referring to FIGS. 6 and 7, the stereoscopic camera includes a first lens group 510, a second lens group 530, a controller 900 and a 3D image sensor 100. The 3D image sensor 100 may have the same structure as the CMOS image sensor shown in FIG. 1. More specifically, the 3D image sensor 100 includes first and second image acquisition regions, which each include a plurality of pixels, a first ROI, which is set within the first image acquisition region 150 and acquires an image from the first lens group 510, a second ROI, which is set within the second image acquisition region and acquires an image from the second lens group 530, and an output signal generation controller, which generates two image signals respectively corresponding to the left and right eyes based on pixel signals extracted from the first and second ROIs and outputs the generated image signals to the outside of the 3D image sensor 100.

Each of the first and second lens groups 510 and 530 may be an ultra small camera lens module combining a plurality of lenses to control focusing. A mechanism for controlling a focal point by controlling the distance between lenses may be employed in each of the first and second lens groups 510 and 530. The first ROI, which is on the left side of the 3D image sensor 100, receives light collected from the first lens group 510, and the second ROI, which is on the left side of the 3D image sensor 100, receives light collected from the second lens group 530.

The controller 900 includes a convergence adjustment unit 910, which outputs a convergence adjustment signal in response to a user manipulation of the stereoscopic camera, and particularly, a knob or a sliding switch of the stereoscopic camera. The output signal generation controller of the 3D image sensor 100 includes, as a counterpart of the convergence adjustment unit 910, a convergence region setting unit, which adjusts the position of at least one of the first and second ROIs minutely in accordance with the convergence adjustment signal output by the convergence adjustment unit 910. Therefore, it is possible to easily adjust convergence without a mechanical movement of the optical system 500.

The controller 900 also includes a lens distance adjustment unit 940, which mechanically adjusts the distance between the first and second lens groups 510 and 530. The first and second lens groups 510 and 530 are coupled to a housing 770 so that they cannot be moved vertically, but can be moved horizontally inside the housing 770 along the inner side of the housing 770. When the first and second lens groups 510 and 530 are farthest apart from each other without any external force applied thereto by an elastic element 750, the distance between the first and second lens groups 510 and 530 may be equivalent to a convergence distance of 85 mm. A first tab 511 is provided on one side of the first lens group 510, and a second tab 531 is provided on one side of the second lens group 530. The first and second tabs 511 and 531 are exposed through two holes, respectively, formed on one side of the housing 770.

An actuator 700, which is formed of a shape memory alloy, is coupled to the first and second lens groups 510 and 530 by penetrating through the first and second tabs 511 and 531. The lens distance adjustment unit 940 may apply a driving signal to both ends 710 and 730 of the actuator 700. When a current is applied to the actuator 700, the actuator 700 may be heated, and thus, the length of the actuator 700 may vary. Since the first and second tabs 511 and 531 are coupled to the actuator 770, they can be moved apart from or closer to each other in accordance with a variation in the length of the actuator 700. Once the first and second tabs 511 and 531 are moved apart from each other by a current applied to the actuator 700, the distance between the first and second lens groups 510 and 530 may be maintained by controlling the current applied to the actuator 700 so as to maintain the temperature of the actuator 700. The lens distance adjustment unit 940 may also apply a lens distance adjustment signal to the 3D image sensor 100.

The output signal generation controller of the 3D image sensor 100 includes, as a counterpart of the lens distance adjustment unit 940, a horizontal distance setting unit, which aligns the first and second ROIs with the first and second lens groups 510 and 530 based on the results of the adjustment of the distance between the first and second lens groups 510 and 530 by the lens distance adjustment unit 940.

The controller 900 also includes a camera shake correction unit 920, which detects a camera shake and outputs a camera shake signal for correcting the camera shake. The structure and operation of the camera shake correction unit 920 are well known to one of ordinary skill in the art to which the present invention pertains. The output signal generation controller of the 3D image sensor 100 includes, as a counterpart of the camera shake correction unit 920, a camera shake region correction unit, which vertically or horizontally moves at least one of the first and second ROIs in accordance with the camera shake signal output by the camera shake correction unit 920.

The controller 900 also includes an optical axis error correction unit 930, which outputs an optical axis correction signal for correcting an optical axis error, if any, in the first and second lens groups 510 and 530. For this, a lookup table may be created in advance based on measurements obtained, at the time of the assembly of the stereoscopic camera, from various ROIs while varying the distance between lenses according to convergence. Then, the optical axis error correction unit 930 can help the 3D image sensor 100 set optimum ROIs for any given convergence distance by referencing the lookup table while taking into consideration the optical properties of each of the first and second lens groups 510 and 530. The output signal generation controller of the 3D image sensor 100 includes, as a counterpart of the optical axis error correction unit 930, an optical axis error correction unit, which corrects an optical axis error by vertically or horizontally moving the first and second ROIs in accordance with the optical axis correction signal.

As described above, it is possible to miniaturize a stereoscopic camera by using a 3D image sensor integrated into a single package. In addition, it is possible to further miniaturize a stereoscopic camera by designing exclusive optical modules therefor. Moreover, it is possible to effective correct various mechanical, optical and physical errors such as an optical axis error or camera shake with ease.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A three-dimensional (3D) image sensor comprising:
one or more image acquisition regions, each image acquisition region having a plurality of pixels; and
an output signal generation controller configured to extract pixel signals from two regions of interest (ROIs) set within the image acquisition regions and output image signals based on the pixel signals, the ROIs being apart from each other.

2. The 3D image sensor of claim 1, wherein the 3D image sensor is implemented on a single substrate obtained from a single substrate.

3. The 3D image sensor of claim 1, wherein the output signal generation controller comprises a convergence region setting unit configured to minutely adjust the position of at least one of the ROIs in accordance with a convergence adjustment signal.

4. The 3D image sensor of claim 1, wherein the output signal generation controller further comprises a camera shake region correction unit configured to vertically or horizontally move each of the ROIs in accordance with a camera shake signal and thus to correct camera shake.

5. The 3D image sensor of claim 1, wherein the output signal generation controller further comprises a horizontal distance setting unit configured to align the ROIs with left and right lenses in an optical system.

6. The 3D image sensor of claim 1, wherein the output signal generation controller further comprises an optical axis error correction unit configured to vertically or horizontally move each of the ROIs in accordance with an optical axis correction signal and thus to correct an optical axis error resulting from an optical axis misalignment.

7. The 3D image sensor of claim 6, wherein the optical axis correction signal varies according to the distance between left and right lenses in an optical system.

8. The 3D image sensor of claim 7, wherein the optical axis correction signal further varies according to a zoom value of the optical system.

9. The 3D image sensor of claim 2, wherein the ROIs are symmetrical with respect to a line drawn between the image acquisition regions.

10. The 3D image sensor of claim 9, further comprising a separation region configured to be provided between the ROIs and have no pixels therein.

11. A stereoscopic camera comprising:
first and second lens groups; and
a 3D image sensor comprising one or more image acquisition regions and an output signal generation controller configured to extract pixel signals from two ROIs set within the image acquisition regions and to output image signals based on the pixel signals, wherein each of the image acquisition regions has a plurality of pixels and the ROIs are apart from each other.

12. The stereoscopic camera of claim 11, further comprising a convergence adjustment unit configured to output a convergence adjustment signal in response to a user manipulation of the stereoscopic camera,
wherein the output signal generation controller comprises a convergence region setting unit configured to minutely adjust the position of at least one of the ROIs in accordance with the convergence adjustment signal.

13. The stereoscopic camera of claim 11, further comprising a lens distance adjustment unit configured to adjust the distance between the first and second lens groups,
wherein the output signal generation controller further comprises a horizontal distance setting unit configured to align the ROIs with the first and second lens groups based on the results of the adjustment performed by the lens distance adjustment unit.

14. The stereoscopic camera of claim 11, further comprising a camera shake correction unit configured to detect camera shake and output a camera shake signal based on the results of the detection,
wherein the output signal generation controller further comprises a camera shake region correction unit configured to vertically or horizontally move each of the ROIs in accordance with the camera shake signal and thus to correct the detected camera shake.

15. The stereoscopic camera of claim 11, further comprising an optical axis error correction unit configured to detect an optical axis error in the first and second lens groups and output an optical axis correction signal based on the results of the detection,
wherein the output signal generation controller further comprises an optical axis error correction unit configured to vertically or horizontally move each of the ROIs in accordance with the optical axis correction signal and thus to correct the detected optical axis error.

16. The stereoscopic camera of claim 15, wherein the optical axis correction signal varies according to the distance between left and right lenses in an optical system.

17. The stereoscopic camera of claim 16, wherein the optical axis correction signal further varies according to a zoom value of the optical system.
